(19) United States
(12) Patent Application Publication
(10) Pub. No.: US 2013/0269117 A1
(43) Pub. Date: Oct. 17, 2013

(54) REVERSIBLE HAND TOOL

(71) Applicant: David Wilkinson, Casula (AU)

(72) Inventor: David Wilkinson, Casula (AU)

(21) Appl. No.: 13/700,541

(22) PCT Filed: May 26, 2011
(86) PCT No.: PCT/AU2011/000642

§ 371 Date: Jun. 7, 2013

(30) Foreign Application Priority Data
May 28, 2010 (AU) 2010902358

(51) Int. Cl. B25F 1/02

(52) U.S. Cl. CPC B25F 1/02
USPC 7/167

(57) ABSTRACT

A reversible hand operated work tool comprising; a shaft including first and second working ends at opposite ends of the shaft; a co operating handle mounted on the shaft and capable of sliding therealong. The hand tool can be adjusted to move from a first working orientation to a second orientation by sliding the handle along the shaft mtennediate said working ends and without jtatnoving the handle form the shaft.

### BACKGROUND

The present invention relates to improvements in hand tools and particularly band tools which have reversible work functions. The invention further relates to a reversible tool which has a handle which slides along a shaft enabling the tool to be operated on one mode and then reversed to a second working mode without removing the handle from the shaft. The invention Anther relates to a hand tool which has improved functionality, is convenient to use and which can be locked into one or other working mode. The invention also provides a reversible tool in which a handle is retained on the shaft as it slides along the shaft to adopt separate work modes.

### PRIOR ART

There are in existence a variety of hand tools which are each designed for performance of specific functions. Typically, these devices are held by a user for manual operation of their work function. A commonly used work tool is a screw driver. The working end of the screw driver is selected according to the compatibility with the bead of the screw that the tool is used with.

Over the years, various types of combination pocket tools have been provided using a handle for holding a shaft having different tools, bits or tool drives on each end. Some tools have had a combination of tools of different types or sizes.

The combination hand tools have been provided to enable a user to select different working ends removing the need to carry two tools for two different work purposes. The known reversible tools include a handle and a shank that bas a working end, such as a screwdriver blade integrally formed at one end. Another working formation may be integrally formed on the opposite end of the shank. A detent located on the shaft, secures the tool or the tool drive within a cavity in

[symbol]

By way of example, U.S. Pat. No. 4,779,493 discloses a combination pocket tool which has a shank and a handle. The shank has a tool at one end and a tool drive at the other end. The handle has a steel sleeve embedded within a hollow cavity. A first detent on the tool drive secures the tool or the tool drive within the cavity of the handle. A second detent on the tool drive assists in securing the tool drive within the cavity or secures a detachable tool to the tool drive. In this case the handle must be removed to expose the second alternative working end then replaced onto the shank.

U.S. Pat. No. 5,533,429 discloses a fastener driving tool insert. In order to enhance the effectiveness of a tool for driving a fastener in a clockwise and/or counter clockwise direction, the tool includes a fastener engaging portion, a rotational movement imparting portion, and a releasable retaining portion. The fastener engaging portion is adapted to engage a fastener for clockwise and/or counter clockwise driven movement in response to rotational movement of the fastener engaging portion. The rotational movement imparting portion is adapted to impart rotational movement to the fastener engaging portion to thereby impart driven movement of the fastener in the clockwise and/or counter clockwise direction. The releasably retaining portion is, adapted to releasably retain the fastener engaging portion in operative relationship with the rotational movement imparting portion.

Conventional screw drivers are generally configured to have a keystone tip or a Phillips head tip of a unitary size. Hence, in use, it is necessary to select the type of screwdriver suitable for use in driving screws of different sizes. In the past attempts have been made to improve on the unitary function and practicality of conventional drivers. The reversible screwdrivers typically have a handle having a shank fixedly provided at its front end and with an interior fitted with a pull handle having a compartment containing a plurality of working bits. The compartment of the pull handle is provided for keeping a plurality of bits of various specifications and sizes. The user may pick out a suitable bit and insert it

[symbol]

Although these screwdriver structures can achieve their respective intended purposes, they have some drawbacks. Although the screwdriver is provided with a plurality of bits to improve its practicality, it is not efficient in moving from one working configuration to another working configuration.

U.S. Pat. No. 5,749,271 discloses a dual purpose ratchet screwdriver including a handle having a chamber in its interior for accommodating a ratchet mechanism, a drive sleeve of the ratchet mechanism being provided to cooperate with a transmission shaft inserted through a hole of the handle. The transmission shaft has a bit at either end, the bit at one end of the transmission shaft being utilized as a structural element for power transmission while the bit at the other end is used to drive a screw.

U.S. Pat. No. 5,901,622 discloses a hand tool with a reversible shaft. The tool comprises a hollow handle accommodating a reversible shaft with a different functionality at each end. The first end of the shaft is configured with an integral telescoping magnetic pick up tool, and a second end of the shaft is adapted to receive modular double-ended screwdriver bits. The reversible shaft is retained within the handle by a conventional spring loaded ball configuration located at the mid-point of the shaft and is prevented from rotating within the handle by preferably two wings projecting radially outwardly from the shaft. The spring loaded ball and the two wings are retained within a corresponding recess and two co-operating slots, respectively. The recess and slots are defined in a metal sleeve molded into the handle.

Screwdrivers with a shaft adapted to retain modular bits which are stored in either the handle or the shaft are well known. Similarly, screwdrivers with modular shafts for different types of screws which are stored in the handle are also well known.

The shaft is interchangeably positionable within the handle in either one of a first position where a first end of the shaft locates within the handle and a second end of said shaft projects outwardly from the handle. A second end of the shaft is adapted to receive screwdriver bits, and a second position where said second end of said shaft locates within said handle and said first end of said shaft projects outwardly from the handle. A hollow handle accommodates a reversible shaft with a different functionality at each end. The reversible shaft is retained within the handle by any suitable means, such as a conventional spring loaded ball preferably located at the mid-point of the shaft and is prevented from rotating within the handle by preferably two wings projecting radially outwardly from the shaft.

To change the function of the tool from a screwdriver to a telescoping tool, the user need only pull out the reversible shaft and re-insert it with the tool facing outward. The cylindrical opening can accommodate the shaft with the screwdriver bit, so that the user does not necessarily have to remove the bit from the shaft and store it before changing functionalities.

There is a need to provide improvements in the known hand tools to increase efficiency of operation and to provide more convenient options for users.

### INVENTION

The present invention seeks to ameliorate the above disadvantages of the prior art by providing an improved hand tool which is more convenient to use that the known reversible band tools.

The present invention provides a hand tool which has reversible work functions. The invention further relates to a reversible tool which has a handle which slides along a shaft enabling the tool to be operated on one mode and then reversed to a second working mode without removing the handle from the shaft. The

[symbol]

In its broadest form the present invention comprises:

a reversible hand operated work tool having a co-operating handle and shaft including work ends at oppose ends of the shaft; wherein the hand tool can be changed from one working mode to another working mode without removal of the handle from the shaft.

In one broad form the present invention comprises:

a hand operated tool comprising:

a shaft having first and second working ends;

the handle connected to the shaft and capable of movement relative to the shaft;

wherein the handle and shaft co operate to allow the handle to move along the shaft between a first working position which allows the first working end to be used while the user grips the handle and a second working position which allows the second working end to be used while the user grips the handle;

and wherein the handle is retained on the shaft while the tool moves between the first and second working positions.

According to a preferred embodiment, the handle and shaft are concentric.

According to a farther embodiment, the handle is lockable to prevent relative movement between the shaft and the handle when either the first or second working positions have been selected.

The handle preferably comprises first and second sleeve members which are retained concentrically along the shaft and which engage a locking assembly. According to a preferred embodiment the locking assembly preferably comprises an inner bearing which receives the shaft, a retaining member which retains the inner bearing and a housing. The retaining member includes a locking arm which extends from the housing and allows the retaining member to co operate with the bearing to move the beating between a first mode of locking engagement with the shaft and a second unlocked mode in which the bearing allows relative movement between the shaft and locking assembly. The shaft according to one embodiment has a flat surface which co operates with the locking arm to effect locking as required. Locking prevents relative axial

[symbol]

According to a preferred embodiment, the locking assembly receives a pivot pin which is anchored in either one or both of the sleeve members of the handle and allows the locking assembly to pivot about the pin (up and down), so it moves between the locking and unlocked modes.

In another broad form the present invention comprises:

a locking assembly for a hand operated tool comprising:

a shaft having first and second working ends;

the handle connected to the shaft and capable of movement relative to the shaft;

wherein the handle and shaft co operate to allow the handle to move along the shaft between a first working position which allows the first working end to be used while the user grips the handle and a second working position which allows the second working end to be used while the user grips the handle;

and wherein the handle is retained on the shaft while the tool moves between the first and second working positions; the locking assembly comprising a retaining member which allows the handle assembly to be selectively locked to the shaft by rotation of the retaining member about a pivot pin connected to the handle thereby allow the locking assembly to be moved between a locked mode and unlocked mode. Preferably the handle is prevented from relative rotation about the shaft and the shaft is fully retained on the shaft.

According to a preferred embodiment, the handle and shaft are concentric. According to a further embodiment, the handle is lockable to prevent relative axial movement between the shaft and the handle when either the first or second working positions have, been selected.

At each end of the shaft is a working formation such as but not limited to a screw driver head such as a Phillips head or other working formation such as a flat head screw driver, allen key (male or female), a torx formation. Different functionality can be provided at each end and used interchangeably by sliding the handle along the shaft to one end or the other. This is quite different from the prior art in that no part of the assembly need be removed and replaced to change from one working mode to another working mode. [symbol] shaft to alter the torque which can be applied to the working end.

For convenience, the specification will refer to “screwdrivers”, but it should be clearly understood that the invention is applicable to various reversible hand tools having a handle which moves relative to a shaft between two working positions and which can have a variety of working ends which can include socket and spanner profiles.

These and other objects of this invention, which will become more apparent upon consideration of the attached claims and drawings and of the following detailed description, are provided in accordance with the preferred embodiment of this invention illustrated by an assembly which enables

Although the invention will be predominantly described with reference to its application to a reversible screw driver, it will be recognised by persons skilled in the art that the invention has a wide variety of applications and with different working ends beyond those to be described by way of example. For example the invention can be adapted as a child's toy manufactured from such materials as but not limited to plastics and polystyrene.

The present invention provides an alternative to the known prior art and the shortcomings identified. The foregoing and other objects and advantages will appear from the description to follow. In the description reference is made to the accompanying representations, which forms a part hereof and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF SUMMARY OF DRAWINGS illustrations.

FIG. 1 shows a side elevation view of a reversible hand tool according to a preferred embodiment with the handle set at one end and opposite a first working end.

FIG. 2 shows the hand tool of FIG. 1 with the handle in an intermediate position along the shaft between the first and second working ends.

FIG. 3 shows the tool of FIG. 1 with the handle set at the first working end to enable use of the tool at the second working end.

FIG. 3a shows a cross section of the shaft.

FIG. 4 shows a sectional view through the handle and locking assembly according to a preferred embodiment.

FIGS. 5a-h shows an end elevation view of the locking assembly moving from a locked mode in which the shaft is engaged with the bearing through various stages to an unlocked mode in which the shaft is disengaged from the bearing.

FIG. 6 shows a schematic view of a locking assembly showing the range of movement of the bearing, retainer and anchor pin.

FIG. 7 shows a hand tool similar to that shown in FIGS. 1-3 but with an alternative locking arrangement.

FIG. 8 shows the handle assembly of FIG. 7 moved out of locking engagement with the shaft and moved in the direction of an opposite end.

FIG. 9 shows the handle assembly of FIG. 7 locked at one end via a locking assembly.

FIG. 10 shows according to one embodiment an end view of a handle assembly which includes a retaining disc which prevents extension of a shaft beyond the handle.

FIG. 11 shows the embodiment of FIG. 11 with retaining disc obstructing the shaft covering.

FIG. 12 shows a perspective view of a reversible hand tool according to a preferred embodiment with the handle set at one end and opposite a first working end.

FIG. 14 shows the tool of FIG. 1.2 with the handle set at an opposite end to enable use of the tool at a second working end.

FIG. 15 shows a shaft isolated from a handle.

FIG. 16 shows the shaft of FIG. 15 rotated ninety degrees.

FIG. 17 shows a perspective view of the locking assembly engaging the shaft with handle removed for clarity.

FIG. 18 shows a cross sectional view of the locking assembly co operating with the shaft in the unlocked mode.

FIG. 19 shows a long sectional view of an assembled work tool according to one embodiment

FIG. 20 shows with corresponding numbering the tool of FIG. 19 rotated 90 degrees.

### DETAILED DESCRIPTION

It will be convenient to hereinafter describe the invention in relation to its application to a screw driver but it will be appreciated that the invention is not limited to that application and may be adapted to alternative constructions. The assembly described herein has advantages over the known art including improved efficiency.

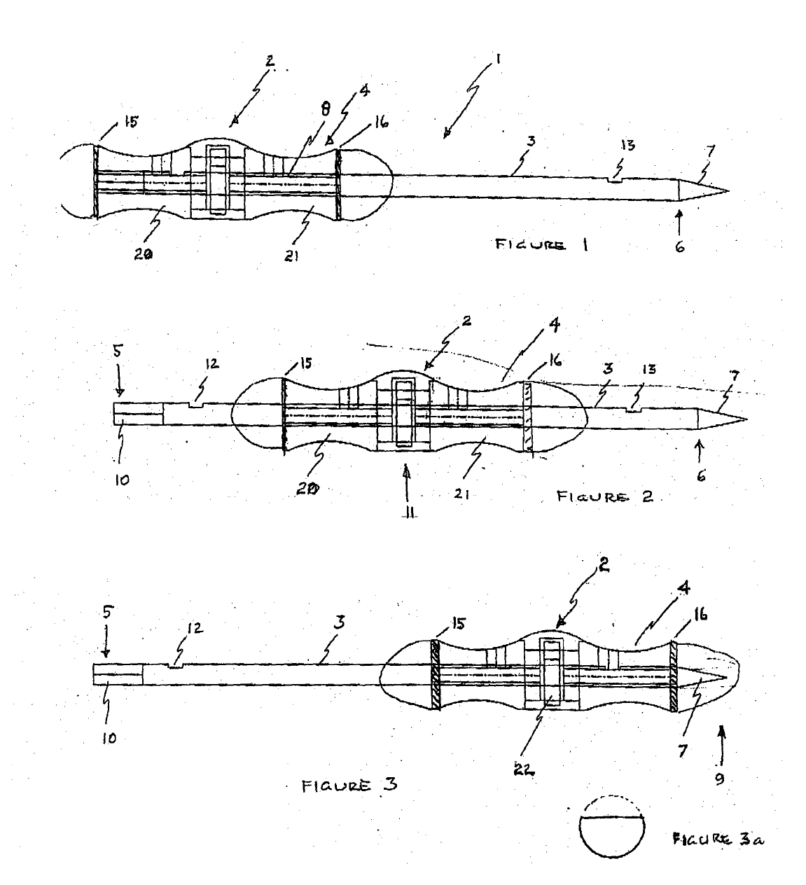

Referring to FIG. 1 there is shown a side elevation view of a reversible hand tool 1 according to a preferred embodiment. Tool 1 includes handle assembly 2 which is adapted to slide along shaft 3 enabling handle 4 to be set at one end 5 of shaft 3, creating at opposite end 6 a first working formation 7.

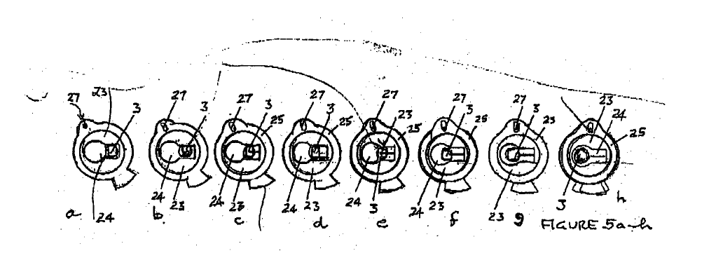

Handle assembly 2 is connected concentrically to shaft 3 and includes a through passage 8 which allows travel of handle 4 along shaft 3. Handle assembly 2 co operates with shaft 3 to allow the handle 4 to move along the shaft, between a first position at end 5 which allows formation 7 of working end 6 to be used while the user grips the handle 4 and a second position 9 (see FIG. 3) which allows the second working formation 10 at end 5 end to be used while the user grips the handle 4. Handle 4 and shaft 3 are concentric. According to a preferred [symbol] have been selected. Stop 15 is employed to ensure handle 4 does not release from shaft 3.

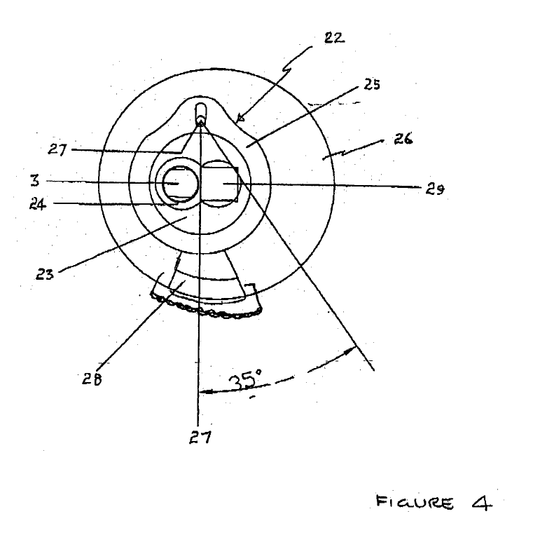

FIG. 2 shows with corresponding numbering the hand tool 1 of FIG. 1 with the handle assembly 2 in an intermediate position 11 along the shaft 3 between the first and second working ends 5, 6. FIG. 3 shows the tool of FIG. 1 with the handle 4 set at the end 6 to enable use of the formation 10 at end 5. As shown in FIGS. 1-3 shaft 3 includes abbreviations 12 and 13 which allow a locking assembly 22 to engage shaft 3 for the purpose of locking the handle assembly 2 opposite the respective working ends 5 and 6. The handle assembly 2 preferably comprises a locking assembly 22. FIG. 3a shows a cross section of the shaft 3.

FIG. 4 shows a sectional view through the handle and locking assembly according to one embodiment. Locking assembly 22 preferably comprises an inner bearing 23 which receives the shaft 3 via opening 24. A retaining member 25 retains the inner bearing 23. Both retaining member 25 and bearing 23 are retained in housing 26. Retaining member 25 is retained by a pivot pin 27 and is capable of rotation thereabout. This allows the retaining member 25 to move up and down. The retaining member 25 includes a locking actuator 28 which extends from the housing 26 and allows the retaining member 25 to co operate with the bearing 23 to move the bearing 23 between a locking mode in which shaft 3 engages locking recess 29 and an unlocked mode in which shaft 3 is located in opening 24 and the bearing allows shaft 3 to travel relative to locking assembly 22. Bearing 23 allows relative axial movement between the shaft 3 and locking assembly 22 thereby enabling handle assembly 2 to slide along shaft 3. Pivot pin 27 is anchored in one or both of the sleeve members 20 or 21 of the handle 4 and allows the locking assembly 22 to pivot about the pin 27 so it moves between the locking and unlocked modes as required by an operator.

At each end of the shaft 3 working formations 7 and 10 are respectively a flat head screw driver and Phillips head but it will be appreciated that other working formations (not shown) may be employed. Different functionality can be selected positions along the shaft 3 to alter the torque which can be applied to The working end as required.

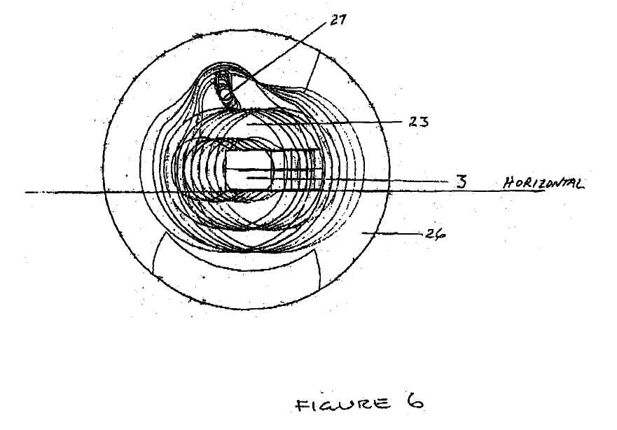

FIGS. 5a-h shows with corresponding numbering an end elevation view of the locking assembly 22 of FIG. 4 as it moves from a locked mode in which the shaft 3 is engaged with the bearing 23 through various stages to an unlocked mode in which the shaft is disengaged from the bearing 23 and is free for axial travel in opening 24.

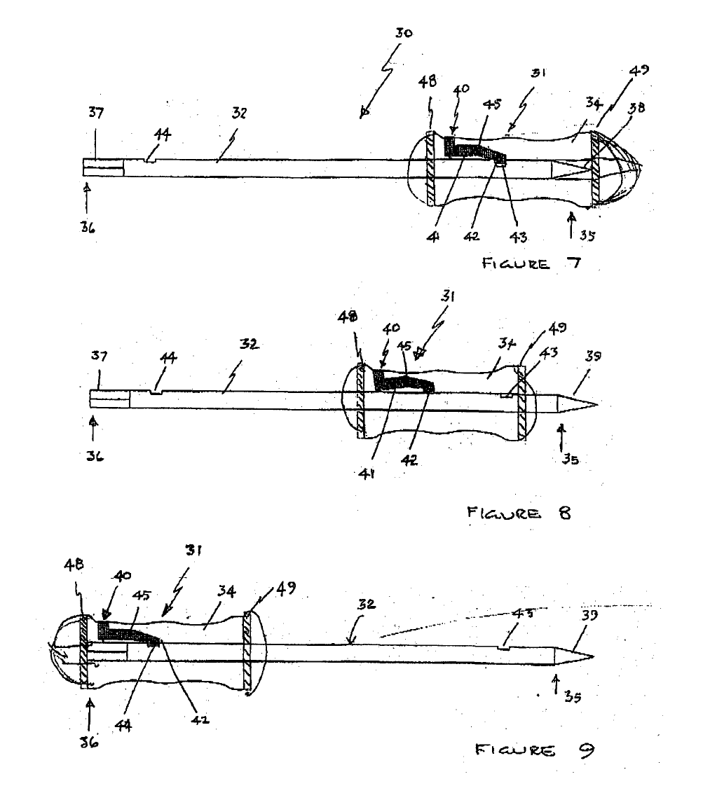

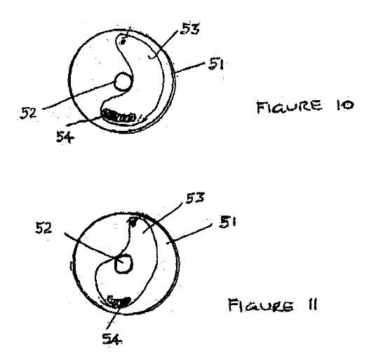

FIG. 6 shows a schematic view of a locking assembly showing the range of movement of the bearing 23, retainer 25 and anchor pin 27. Bearing 23 allows the contact surfaces to remain horizontal. An elongated opening about the pivot pin makes this possible.

FIG. 7 shows a hand tool 30 similar to that shown in FIGS. 1-3 but with an alternative locking arrangement. Tool 30 includes handle assembly 31 which is adapted to slide along shaft 32 enabling handle 34 to be set at one end 35 of shaft 32, creating at opposite end 36 a first working formation 37.

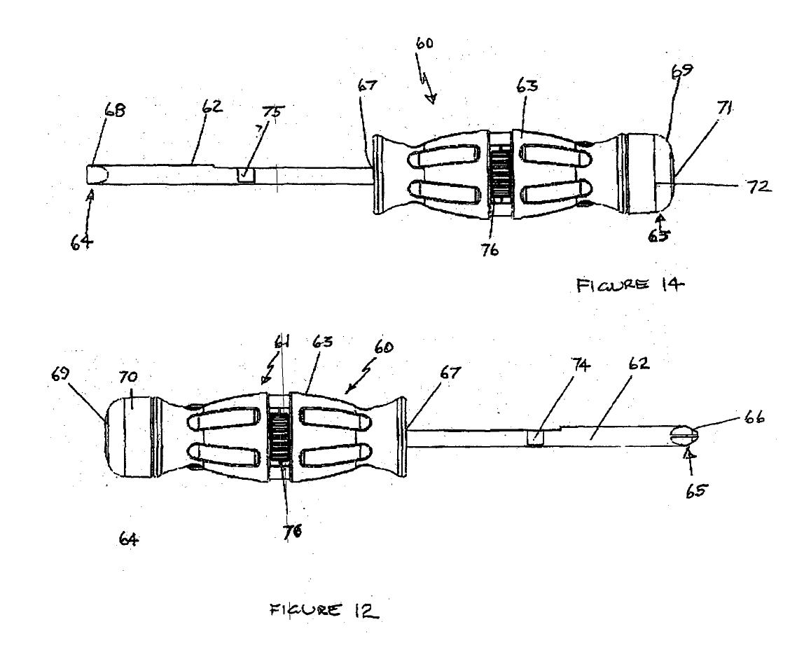

Handle assembly 31 is connected concentrically to shaft 32 and includes a through passage 38 which allows travel of handle 34 along shaft 32. Handle assembly 31 co operates with shaft 32 to allow the handle 34 to move along the shaft 32 between a fast position which allows formation 37 of end 36 to be used while the user grips the handle 34 and a second position (see FIG. 9) which allows the second working formation 39 at end 35 to be used while the user grips the handle 34. Handle 34 and shaft 32 are concentric. Handle 34 is lockable to prevent relative movement between the shaft 32 and the handle 34 when either the first or second working positions have been selected. Locking assembly 40 comprises a pawl 41 terminating in tang 42 pivotally attached to handle 34 via pin 45. FIG. 7 shows locking assembly 40 in locking engagement with shaft 32 as tang 42 is in engagement with recess 43 of shaft 32. Moon shaped discs 48 and 49 operate to prevent release of the handle assembly 31 releasing from shaft 32. [symbol] shaft 32 and moved in the direction of end 36. FIG. 9 shows the handle assembly 31 locked at end 36 via locking assembly 40. Tang 42 is shown engaging recess 44 of shaft 32 to lock handle assembly 31. Handle assembly 31 can be simply relocated along shaft to either end depending upon which working end is required. In this embodiment, handle assembly 31 can be removed from shaft if required but removal from shaft 32 is not essential to change to the opposite working end of shaft 32.

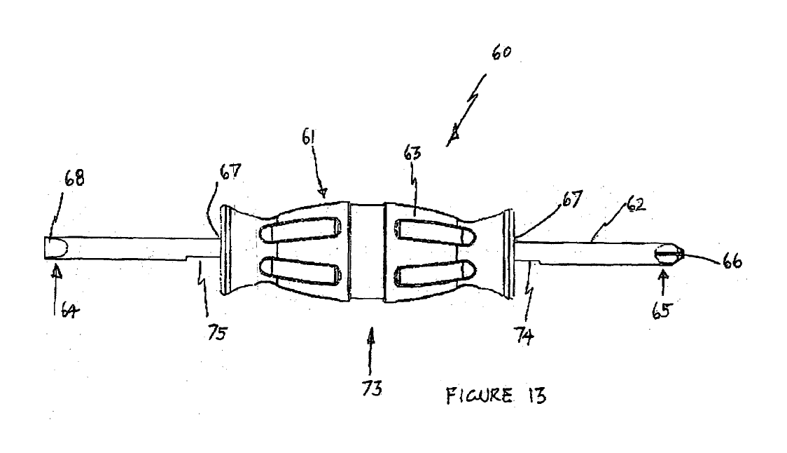

As a measure of user safety according to a preferred embodiment, and as shown in FIGS. 10 and 11, there is provided at end 50 of handle 51 a spring loaded disc which acts to prevent unwanted movement of shaft 52 axially beyond the end of handle 51. Disc 53 is biased under the action of spring 54 to urge disc 53 over the end of shaft 52 as shown in FIG. 11. Such protection may be provided at either rend of handle 51 as required. This will provide user safety and in particular a safeguard against the shaft stabbing the users hand.

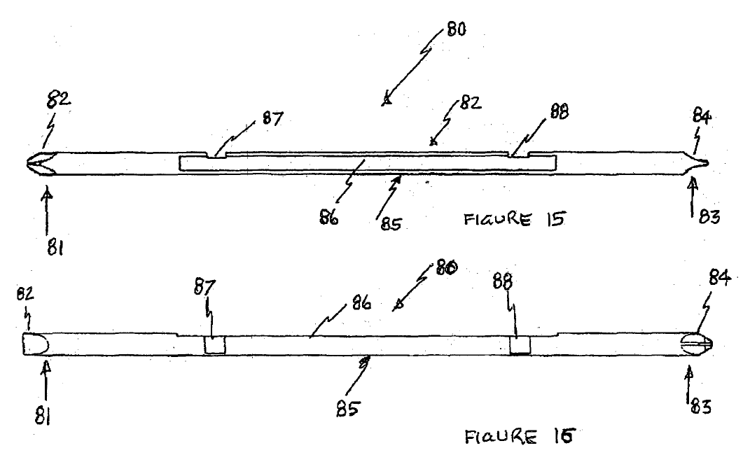

Referring to FIG. 12 there is shown a side elevation view of a reversible hand tool 60 according to a preferred embodiment Tool 60 includes handle assembly 61 which is adapted to slide along shaft 62 enabling handle. 63 to be set at one endue of shaft 62, creating at opposite end 65 a first working formation 66. Handle assembly 61 is connected concentrically to shaft 62 and includes a through passage 67 which allows travel of handle 63 along shaft 62. Handle assembly 61 co operates with shaft 62 to allow the handle 63 to move along the shaft 62 between a first position at end 64 which allows formation 66 of working end 65 to be used while the user grips the handle 63 and a second position (see FIG. 3) which allows the second working formation 68 at end 64 end to be used while the user grips the handle 63. Handle 63 and shaft 62 are concentric. According to a preferred embodiment, the handle 63 is lockable to prevent relative movement between the shaft 62 and the handle assembly 63 when either the first or second working positions 64 or 65 have been selected. Stop 69 of end cap 70 and stop 71 of end cap 72 are employed to ensure handle 63 does not release from shaft 62. [symbol] with the handle assembly 61 in an intermediate position 73 along the shaft 62 between the first and second working ends 64 and 65.

FIG. 14 shows the tool of FIG. 12 with the handle 61 set at the end 65 to enable use of the formation 68 at end 64. As shown in FIGS. 12-14 shaft 62 includes abbreviations 74 (see FIGS. 12) and 75 which allow a locking assembly 76 to engage shaft 62 for the purpose of locking the handle assembly 76 opposite the respective working ends 64 and 65. The handle assembly 76 is retained concentrically along the shaft 62 and which engage a locking assembly 73.

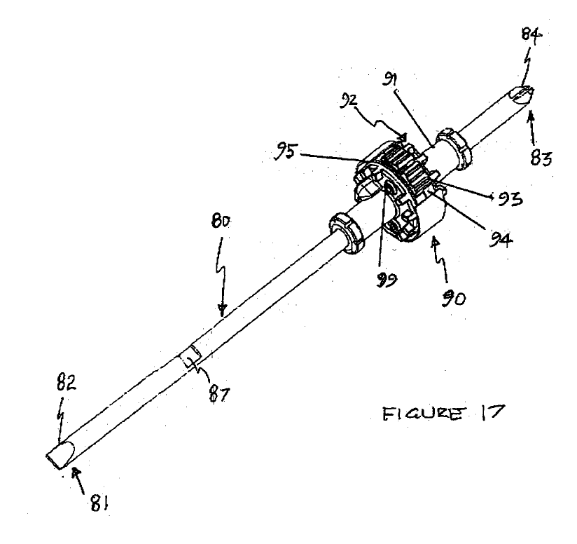

FIG. 15 shows a side elevation of a typical shaft 80 isolated from a handle assembly according to one embodiment. Shalt 80 comprises a first end 81 with a working formation 82 and a second end 83 with a working formation 84. Intermediate ends 81 and 83 is a profile part or formation 85 which is configured to receive a handle such as handle 63 shown in FIG. 13 and, enables handle 63 to be selectively and slideably retained on shaft 80. Formation 85 includes a longitudinal recess 86 and slots 87 and 88.

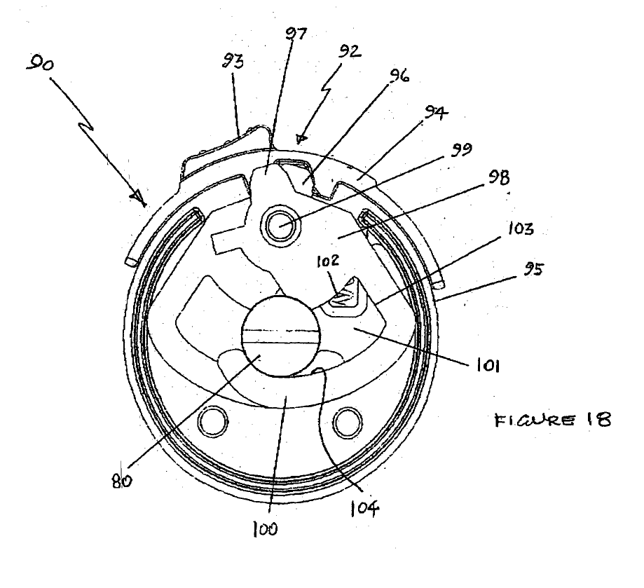

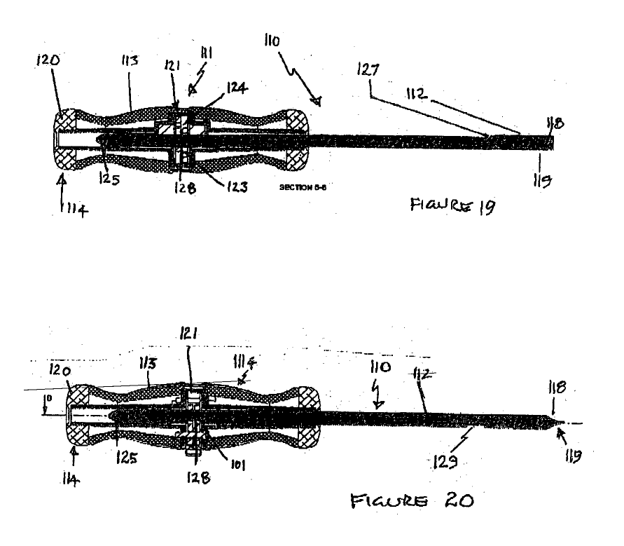

FIG. 16 shows with corresponding numbering the shaft 80 of FIG. 15 rotated 90 degrees includes a longitudinal recess 86 and slots 87 and 88. Longitudinal recess 86 of formation 85 enables engagement with a corresponding profile of a handle (not shown) to enable the handle to be selectively moved along shaft 80. Slots 87 and 88 receive the actuating member 98 (see FIG. 18) to restrain the handle from movement relative to shaft 80 depending upon the end selected for the handle. If working end 81 is to be used the actuating member of the locking assembly 73 will engage slot 88. Likewise, if working end 83 is to be used, the actuating member 98 of the locking assembly 73 will engage slot 87.

FIG. 17 shows with corresponding numbering a perspective view of a shaft 80 incorporating a locking assembly 90 when isolated from a handle assembly. Locking assembly 90 is mounted on sleeve 91 which is capable of sliding along [symbol] Saddle 94 is capable of moving circumferentially relative to housing 95 to enable locking and unlocking of sleeve 91 about shaft 80 so that a handle can be selectively restrained from movement relative to shaft 80.

FIG. 18 shows a sectional view of locking assembly 90 engaging shaft 80. Assembly 90 includes locking member 92 having a formation 93 which is engageable by a users finger and which is connected to a saddle 94. Saddle 94 is capable of moving circumferentially relative to housing 95 to enable locking and unlocking of housing 95 and sleeve 91 (see FIG. 17) about shaft 80 so that a handle can be selectively restrained from movement relative to shaft 80. Locking member 92 includes a recess 96 which engages tab 97 of actuating member 98. Actuating member 98 is pivotally attached via pivot hinge 99 and terminates in engaging arm 100. Engaging arm 100 engages shaft 80 which moves within slot 101 as actuating member 98 rotates about pivot hinge 99. As actuating member 98 rotates towards shaft 80, shaft 80 is urged into slot 101 and profiles 102, 103 and 104 of slot 101 engages corresponding slots 87 and 88 (see FIG. 15) shaft 80 to capture shaft 80 and prevent movement of the housing 95 along the shaft. Since the assembly 90 is mounted on the handle the handle is prevented from axial sliding along shaft 80. The locking assembly includes a spring bias which urges the actuating member away from engagement with the shaft 80 so that the locking assembly is naturally biased to the unlocked position. Alternatively the actuating member can be biased to the locked position by spring loading. To enable the handle to transfer applied torque to the shaft, a keyway is provided on the shaft to prevent any relative movement between the shaft and the handle.

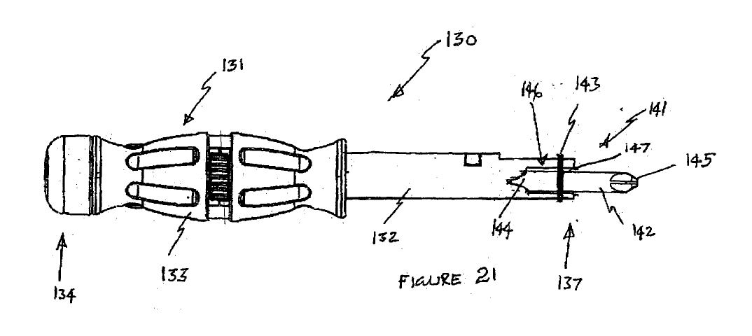

FIG. 19 shows a long sectional view of an assembled work tool 1 to according to one embodiment. Tool 110 includes handle assembly 111 which is adapted to slide along shaft 112 enabling handle 113 to be set at one end 114 of shaft 112, creating at opposite end 115 a first working formation 116. Handle assembly 111 is connected concentrically to shaft 112 and includes a through passage 117 which allows travel of handle 113 along shaft 112. Handle assembly 111 co operates with shaft 112 to allow the handle 113 to move along the shaft between concentric. According to a preferred embodiment, the handle 113 is lockable to prevent relative movement between the shaft 112 and the handle 113 when either The first or second working positions at ends 114 or 119 of shaft 112 are selected. Stop 120 is employed to ensure shaft 112 does not release from handle 113.

Assembly handle assembly 111 includes locking assembly 121. Assembly 121 includes a locking member 122 having a formation 123 which is engageable by a users finger and which is connected to a saddle 124. Saddle 124 capable of moving circumferentially to enable locking and unlocking of handle assembly 111 about shaft 112 so that a handle can be selectively restrained from movement relative to shaft 112. As locking member 124 is rotated actuating member 123 rotates towards shaft 112, shaft 112 is urged into,slot 128 thereby preventing handle from sliding along shaft 112. Shaft 112 comprises a first end working formation 125 and second end working formation 118. Intermediate ends 125 and 119 is a profile part or formation 126 which is configured to receive handle 113 to be selectively and slideably retained on shaft 112. Once the locking assembly 121 is engaged, shaft 112 is prevented from axial movement relative to handle 113, by engagement between locking assembly 121 and slot 128. Handle 113 is prevented from relative rotation about shaft 112 by a keyway in locking assembly 121.

FIG. 20 shows with corresponding numbering the tool of FIG. 19 rotated 90 degrees. Formation 126 includes a longitudinal recess 127 and slots 128 and 129. Slots 128 and 129 allow retention of handle 113 against shaft 112. Formation 126 which is configured to receive handle 113 enables the handle to be selectively and slideably retained on shaft 112. End 125 of shaft 112 is shown terminated short of end 114 of handle 113. This shaft 112 can penetrate beyond end cap 120 as handle 113 is moved towards end 119 when the tool is to be reversed. Also, handle 113 can be positioned on shaft 112 so that end 125 stops short of or abuts end cap 120.

In a further embodiment of the invention as shown in FIG. 21, the working end of the shaft may be adapted with an adjustable working end which enables the embodiment. Tool 130 includes handle assembly 131 which is adapted to slide along shaft 132 enabling handle 133 to be set at one end 134 of shaft 132, creating at opposite end 135 a working formation 136. Handle assembly 131 is connected concentrically to shaft 132 and is capable of travel therealong. Handle assembly 131 co operates with shaft 132 to allow the handle 133 to move along the shaft 132 between a first position at end 134 and a second position at end 137. Working end 137 is used while a user grips the handle 133.

According to a preferred embodiment, the handle 133 is lockable to prevent relative movement between the shaft 132 and the handle assembly 133 when either the first or second ends 134 or 137 have been selected. Stop 139 of end cap 140 is employed to ensure handle 133 does not release from shaft 132 beyond handle 133. End 137 is characterised in that it comprises a reversible working head 141 mounted on shaft 132. Head 141 comprises a working tip 142 mounted on pivot hinge 143. Shaft 132 has a bifurcated portion 146 which receives and retains working tip 142 such that working tip 142 can rotate either through 180 degrees or through 360 degrees about pivot hinge 143 thereby allowing a user to select alternative working end profiles 144 and 145. In an alternative embodiment, working tip 142 may be adapted for release from recess 147 defined by bifurcated portion 146 so that a user can extract (pull out) working tip 142 and reverse it so that working profile 145 is inserted in recess 147 and profile 144 is presented as the working formation. In this latter embodiment, the profile of working tip 142 is shaped to ensure a key in lock co-operation with recess 147 to ensure there is no relative rotation between working tip 142 and shaft 132 when a user applies torque to the tool. The above arrangements described in FIG. 21 may be adapted at either end of shaft 132 so that the user has according to one embodiment, up to four working profile options to choose from.

The embodiments previously described are examples only and it will be appreciated by persons skilled in the art that the configuration may be adjusted to accommodate a work tool assembly of different sizes, modes of operation, and configurations. For example the shaft may have a hexagonal, polygonal or other cross section at tis opposite end. The present invention obviates the disadvantages of the prior art and provides other advantages which are apparent from the description herein. In certain cases the invention will be adapted to accommodate prescribed requirements and applications.

It will be further appreciated that the work tool described herein, can be manufactured with a variety of working end options. For instance the profile part on the shaft which forms each working end, can be selected from a variety of working formations. For example, a work tool may incorporate on one work end a flat end screw driver and at its other end a Phillips head screw driver. Alternatively, the working ends may be selected from male or female allen keys of the same or different sizes or and any combination of those along with a flat end or Phillips head end. Each worms end formation may be provided in different sizes.

It will be appreciated that the above description relates to the preferred embodiment by way of example only. Many variations on the invention will be obvious to those knowledgeable in the field, and such obvious variations are within the scope of the invention as described and claimed, whether or not expressly described.

It will be recognised by persons skilled in the art that numerous variations and modifications may be made to the invention described herein without departing from the overall spirit and scope of the invention.

1. A reversible hand operated work tool comprising;
a shaft including first and second working ends at opposite ends of the shaft;
a co operating handle mounted on the shaft and capable of sliding therealong;
wherein, the hand tool can be adjusted to move from a first working orientation to a second orientation by sliding the handle along the shaft intermediate said working ends.

2. A work tool according to claim 1 wherein the handle is capable of movement between the working ends without removal of the handle from the shaft.

3. A work tool according to claim 2 wherein, a longitudinal axis through the handle is concentric with a longitudinal axis through the shaft.

4. A work tool according to claim 3 wherein, the shaft includes at least one formation intermediate the working ends which enables locking of the handle from relative movement along the shaft.

5. A work tool according to claim 4 wherein, said locking of the handle relative to the shaft is provided by a locking assembly.

6. A work tool according to claim 5 wherein the locking assembly is mounted in the handle.

7. A work tool according to claim 6 wherein, the locking assembly selectively engages the shaft to effect locking of the handle against the shaft.

8. A work tool according to claim 7 wherein the locking assembly comprises;
a housing, a saddle including a boss for movement of the saddle relative to the housing, an actuating member pivotally attached to the housing and which includes a tab which engages a recess in the saddle.

9. A work tool according to claim 8 wherein the actuating member pivots about a hinge thereby enabling the actuating member to advance and retract responsive to circumferential movement of the saddle.

10. A work tool according to claim 9 wherein a profile part of the actuating member and an actuating arm define a slot in which the shaft travels as the actuating member advances and retracts.

11. A work tool according to claim 10 wherein the actuating member moves between an unlocked mode and locked mode responsive to movement of the saddle.

12. A work tool according to claim 11 wherein the shaft includes formations which receive the profile part of the actuating member and the actuating arm, as the actuating member advances responsive to travel of the boss in a first direction and retracts responsive to travel of the boss in a second direction.

13. A work tool according to claim 12 wherein engagement between the formations in the shaft and the profiled part of the actuating member and between the shaft and actuating arm prevent movement of the housing relative to the shaft.

14. A work tool according to claim 13 wherein the handle is prevented from moving relative to the shaft when the actuating member engages the shaft in the locked mode.

15. A work tool according to claim 14 wherein the tool comprise a reversible screw driver.

16. A work tool according to claim 15 wherein the shaft has a circular cross section for at least part of its length.

17. A work tool according to claim 16 wherein the screw driver is reversible without removal of the handle from the shaft.

18. A work tool according to claim 17 wherein the handle has finger grippable formations which facilitate application of torque

19. A work tool according to claim 18 wherein the shaft of the screw driver has at a first working end a flat head profile.

20. A work tool according to claim 19 wherein, the shaft has at a second working end a flat head profile

21. A work tool according to claim 20 wherein, the first and second working end flat head profiles are different sizes.

22. A work tool according to claim 18 wherein, the shaft of the screw driver has at a first working end a phillips head profile.

23. A work tool according to claim 22 wherein, the shaft has at a second working end a phillips head profile.

24. A work tool according to claim 23 wherein, the first and second working end Phillips head profiles are different sizes.

25. A work tool according to claim 18 wherein, the shaft of the screw driver has at a first working end a flat end profile.

26. A work tool according to claim 25 wherein, the shaft has at a second working end a Phillips head profile

27. A work tool according to claim 18 wherein, the shaft of the screw driver has at a first working end a male allen key profile.

28. A work tool according to claim 27 wherein the shaft has at a second working end a male allen key profile

29. A work tool according to claim 28 wherein, the first and second working end male allen key profiles are different sizes.

30. A work tool according to claim 18 wherein, the shaft of the screw driver has at a first working end a female allen key profile.

31. A work tool according to claim 30 wherein, the shaft has at a second working end a female allen key profile.

32. A work tool according to claim 31 wherein, the first and second working end female allen key profiles are different sizes.

33. A work tool according to claim 18 wherein the shaft of the screw driver has at a first working end a male allen key profile.

34. A work tool according to claim 33 wherein the shaft has at a second working end a female allen key profile.

35. A work tool according to claim 34 wherein the first and second working end male allen key profiles are different sizes.

36. A work tool according to claim 18 wherein, the shaft of the screw driver has at a first working end a male allen key profile.

37. A work tool according to claim 36 wherein the shaft has at a second working end a flat end profile.

38. A work tool according to claim 18 wherein, the shaft of the screw driver has at a first working end a female allen key profile.

39. A work tool according to claim 38 wherein, the shaft has at a second working end a flat end profile

40. A work tool according to claim 18 wherein, the shaft of the screw driver has at a first working end a male allen key profile.

41. A work tool according to claim 40 wherein, the shaft has at a second working end a Phillips head end profile

42. A work tool according to claim 18 wherein, the shaft of the screw driver has at a first working end a female allen key profile.

43. A work tool according to claim 42 wherein, the shaft has at a second working end a phillips head end profile

44. A work tool according to claim 18 wherein the shaft of the screw driver has at a first working end a female allen key profile.

45. A work tool according to claim 44 wherein the shaft has at a second working end a flat end profile

46. A hand operated tool comprising:
a shaft having first and second working ends;
the handle connected to the shaft and capable of movement relative to the shaft;
wherein the handle and shaft co operate to allow the handle to move along the shaft between a first working position which allows the first working end to be used while the user grips the handle and a second working position which allows the second working end to be used while the user grips the handle;
and wherein the handle is retained on the shaft while the tool moves between the first and second working positions.

47. A work tool according to claim 46 wherein, the handle is lockable to prevent relative movement between the shaft and the handle when either the first or second working positions have been selected.

48. A work tool according to claim 47 wherein, the handle comprises first and second sleeve members which are retained concentrically along the shaft and which engage a locking assembly.

49. A work tool according to claim 48 wherein, the locking assembly comprises an inner bearing which receives the shaft, a retaining member which retains the inner bearing and a housing.

50. A work tool according to claim 49 wherein, the retaining member includes a locking arm which extends from the housing and allows the retaining member to co operate with the bearing to move the bearing between a first mode of locking engagement with the shaft and a second unlocked mode in which the bearing allows relative movement between the shaft and locking assembly.

51. A work tool according to claim 50 wherein, the shaft includes a flat surface region which co operates with the locking arm to effect locking of the handle against the shaft, thereby preventing relative axial movement between the handle and the shaft.

52.-58. (canceled)
